(19) United States
(12) Patent Application Publication
(10) Pub. No.: US 2018/0361865 A1
(43) Pub. Date: Dec. 20, 2018

(54) POWER SUPPLY UNIT FOR A VEHICLE

(71) Applicant: HONDA MOTOR CO., LTD., Tokyo (JP)

(72) Inventor: Masashi Bando, Wako-shi (JP)

(73) Assignee: HONDA MOTOR CO., LTD., Tokyo (JP)

(21) Appl. No.: 16/007,235

(22) Filed: Jun. 13, 2018

(30) Foreign Application Priority Data
Jun. 14, 2017 (JP) 2017-117009

(51) Int. Cl. B60L 11/18

(52) U.S. Cl. CPC B60L 11/1838; B60L 11/1861; B60L 2210/40; B60L 2230/10; B60L 11/1816

(57) ABSTRACT

A power supply unit (1) for a vehicle (V) includes: a high-voltage circuit (10) to which a high-voltage battery (BH) is provided; a low-voltage circuit (20) to which a low-voltage external terminals (27) are provided; a VCU (30) provided between the high-voltage circuit (10) and the low-voltage circuit (20); a bypass line (71) connecting the high-voltage circuit (10) and low-voltage circuit (20) to circumvent the VCU (30); and a bypass diode (72) provided in the bypass line (71). The ECU (60), during external charging by way of the low-voltage external charger (CL), causes the VCU (30) to stop, and supplies electric current from the low-voltage external charger (CL) to the high-voltage battery (BH) via the bypass line (71) in a case of the voltage of the high-voltage battery (BH) being lower than the charging voltage of the low-voltage external charger (CL).

This application is based on and claims the benefit of priority from Japanese Patent Application No. 2017-117009, filed on 14 Jun. 2017, the content of which is incorporated herein by reference.

### BACKGROUND OF THE INVENTION

### Field of the Invention

The present invention relates to a power supply unit for a vehicle.

### Related Art

Electric vehicles such as hybrid automobiles and electric automobiles travel by way of driving a motor using the electric power supplied from batteries. In addition, the batteries equipped to electric vehicles can charge by the electric power supplied from a charger outside of the vehicle such as a common charging facility or quick charging facility.

Patent Document 1 shows technology with the object of improving the charging efficiency of external charging using such an external charger. Patent Document 1 supplies electric current to a battery from the external charger in a vehicle to which a step-up capacitor is provided between the external charger and the battery, by isolating the gate of the power element in the step-up capacitor and causing rectification operation to be conducted, in a case of the voltage on the battery side being lower than the voltage on the external charger side.
Patent Document 1: Japanese Unexamined Patent Application, Publication No. 2009-22138

### SUMMARY OF THE INVENTION

According to the technology of Patent Document 1, by continuing to isolate the gate during charging, it is possible to suppress switching loss in proportion thereto. However, the electric current will regularly continue to flow to the reactor and circulation diode during charging with the technology of Patent Document 1. For this reason, with the technology of Patent Document 1, the size of the circulation diode must be made large, and thus the requirement arises to enlarge the power module overall. In addition, since reactor loss also occurs with the technology of Patent Document 1, there is risk of the charging efficiency declining.

The present invention has an object of providing a vehicle electric power supply source that charges an electrical storage device by supplying electric current via a voltage transducer from an electrical supply source to the electrical storage device, and can reduce the loss during charging.

According to a first aspect of the present invention, a power supply unit (for example, the power supply unit 1, 1A described later) for a vehicle (for example, the vehicle V described later) includes: a first circuit (for example, the high-voltage circuit 10 described later) to which a first electrical storage device (for example, the high-voltage battery BH described later) is provided; a second circuit (for example, the low-voltage circuit 20, 20A described later) to which a second external charger (for example, the low-voltage external charger CL described later) is connected; a voltage transducer (for example, the VCU 30 described later) having a step-up function of connecting the first circuit and the second circuit, boosting a voltage applied to a side of the second circuit, and outputting to a side of the first circuit; a control device (for example, the ECU 60, 60A described later) that controls the voltage transducer; a first charging parameter acquisition means (for example, the sensor unit SH described later) for acquiring a value of a first charging parameter having a correlation with a charging amount of the first electrical storage device; a bypass line (for example, the bypass line 71 described later) that connects the first circuit and the second circuit to circumvent the voltage transducer; and a diode (for example, the bypass diode 72 described later) that is provided to the bypass line and causes electric current to pass from the side of the second circuit to the side of the first circuit, in which the control device, during external charging by the second external charger, stops the voltage transducer, and supplies electric current from the second external charger to the first electrical storage device via the bypass line, in a case of the value of the first charging parameter being smaller than the determination value associated with the charging voltage of the second external charger.

According to a second aspect of the present invention, in this case, it is preferable for the control device, during external charging by the second external charger, to supply electric current from the second external charger to the first electrical storage device by causing step-up operation to be executed in the voltage transducer, in a case of the value of the first charging parameter being at least the determination value.

According to a third aspect of the present invention, a power supply unit (for example, the power supply unit 1, 1A described later) for a vehicle (for example, the vehicle V described later) includes: a first circuit (for example, the high-voltage circuit 10 described later) to which a first electrical storage device (for example, the high-voltage battery BH described later) is provided; a second circuit (for example, the low-voltage circuit 20, 20A described later) to which a second external charger (for example, the low-voltage external charger CL described later) is connected; a voltage transducer (for example, the VCU 30 described later) having a step-up function of connecting the first circuit and the second circuit, boosting a voltage applied to a side of the second circuit, and outputting to a side of the first circuit; a control device (for example, the ECU 60, 60A described later) that controls the voltage transducer; a bypass line (for example, the bypass line 71 described later) that connects the first circuit and the second circuit to circumvent the voltage transducer; and a diode (for example, the bypass diode 72 described later) that is provided to the bypass line and causes electric current to pass from the side of the second circuit to the side of the first circuit, in which a voltage during full charge of the first electrical storage device is higher than a charging voltage of the second external charger, and in which the control device, during external charging by the second external charger, first causes the voltage transducer to stop and supplies electrical current from the second external charger to the first electrical storage device via the bypass line, and subsequently, until the first electrical storage device reaches full charge, causes step-up operation to be executed in the voltage transducer and supplies electrical current from the second external charger to the first electrical storage device.

According to a fourth aspect of the present invention, in this case, it is preferable for the voltage transducer to further have a step-down function of dropping a voltage applied to the side of the first circuit and outputting to the side of the second circuit, for a vehicle accessory to be connected to the second circuit, and for electric current from the second external charger to be supplied during external charging by the second external charger, and electric current from the first electrical storage device is supplied by causing step-down operation to be executed in the voltage transducer during vehicle travel, to the vehicle accessory.

According to a fifth aspect of the present invention, in this case, it is preferable for a first external charger (for example, the high-voltage external charger CH described later) having a higher charging voltage than the second external charger to be connected to the first circuit, and electric current from the first external charger to be supplied to the first electrical storage device during external charging by way of the first external charger.

According to a sixth aspect of the present invention, in this case, it is preferable for a first external charger (for example, the high-voltage external charger CH described later) having a higher charging voltage than the second external charge to be connected to the first circuit; and the control device, during external charging by the first external charger, to supply electric current from the first external charger to the vehicle accessory by way of causing the voltage transducer to execute step-down operation.

According to a seventh aspect of the present invention, in this case, it is preferable for a second electrical storage device (for example, the low-voltage battery BL described later) having a lower voltage during full charge than the first electrical storage device to be provided to the second circuit; and electric current from the first external charger to be supplied by causing the voltage transducer to execute step-down operation during external charging by way of the first external charger, and electric current from the second external charger is supplied during external charging by way of the second external charger, to the second electrical storage device.

According to an eighth aspect of the present invention, a power supply unit (for example, the power supply unit 1A described later) for a vehicle (for example, the vehicle VA described later) includes: a first circuit (for example, the high-voltage circuit 10 described later) to which a first electrical storage device (for example, the high-voltage battery BH described later) is provided; a second circuit (for example, the low-voltage circuit 20 described later) to which a second electrical storage device (for example, the low-voltage battery BL described later) is provided; a voltage transducer (for example, the VCU 30 described later) having a step-up function of connecting the first circuit and the second circuit, and boosting a voltage applied to a side of the second circuit and outputting to a side of the first circuit; a first charging parameter acquisition means (for example, the sensor unit SH described later) for acquiring a value of a first charging parameter having a correlation with a charging amount of the first electrical storage device; a control device (for example, the ECU 60A described later) that controls the voltage transducer; a bypass line (for example, the bypass line 71 described later) that connects the first circuit and the second circuit to circumvent the voltage transducer; and a diode (for example, the bypass diode 72 described later) that is provided to the bypass line and causes electric current to pass from the side of the second circuit to the side of the first circuit, in which the control device, during charging of the first electrical storage device by way of the second electrical storage device, causes the voltage transducer to stop, and supplies electric current from the second electrical storage device to the first electrical storage device via the bypass line, in a case of a value of the first charging parameter being less than a determination value associated with the voltage of the second electrical storage device.

In the first aspect of the present invention, the first circuit to which the first electrical storage device is provided and the second circuit to which the second external charger is connected are connected by the voltage transducer having a step-up function. In addition, the present invention provides a bypass line that connects this first circuit and second circuit to circumvent the voltage transducer, and provides a diode to this bypass line that passes electric current from the second circuit side to the first circuit side. Then, the control device, during external charging by the second external charger, causes the voltage transducer to stop, and supplies electric current from the second external charger to the first electrical storage device via the bypass line using the potential difference between the second external charger and the first electrical storage device, in a case of the value of the first charging parameter having a correlation with the charging amount of the first electrical storage device being less than the determination value associated with the charging voltage of the second external charger. Therefore, according to the present invention, since it is possible to perform external charging by circumventing the voltage transducer during low voltage of the first electrical storage device, it is possible to reduce the loss during external charging in proportion thereto.

According to the second aspect of the present invention, the external charging done via the aforementioned bypass line is limited to a case of the value of the first charging parameter being less than the determination value. Therefore, the present invention, during external charging by the second external charger, supplies electric current from the second external charger to the first electrical storage device by causing the voltage transducer to execute step-up operation in the case of the value of the first charging parameter being at least the determination value. It is thereby possible to make the first electrical storage device fully charged by the external charging using the second external charger, even if a case of a battery for which the voltage during full charge thereof is higher than the charging voltage of the second external charger being used as the high-voltage battery BH, for example.

In the third aspect of the present invention, the first circuit to which the first electrical storage device is provided and the second circuit to which the second external charger is connected are connected by the voltage transducer having a step-up function. In addition, the present invention provides a bypass line that connects this first circuit and second circuit to circumvent the voltage transducer, and provides a diode to this bypass line that passes electric current from the second circuit side to the first circuit side. Then, the control device, in a case of performing, by way of the second external charger, external charging of the first electrical storage device for which the voltage during full charge thereof is higher than the charging voltage of the second external charger, first causes the voltage transducer to stop, and supplies electric current from the second external charger to the first electrical storage device via the bypass line. During an initial stage of external charging, since it is thereby possible to perform external charging by circumventing the voltage transducer, it is possible to reduce the loss during external charging in proportion thereto. In addition, from after the voltage of the first electrical storage device rises to a certain extent by way of external charging via this bypass line, until the first electrical storage device reaches full charge, it is possible to continue external charging until the voltage of the first electrical storage device attains the voltage during full charge, which is higher than the charging voltage, by executing step-up charging in the voltage transducer. According to the above, it is possible to make the first electrical storage device fully charged while reducing the loss during external charging according to the present invention, even if a case of the voltage during full charge of the first electrical storage device being higher than the charging voltage of the second external charger.

In the fourth aspect of the present invention, a voltage transducer having a step-down function is used as the voltage transducer, and connects a vehicle accessory to the second circuit. In addition, during external charging by the second external charger, the present invention supplies electric current from the second external charger to the vehicle accessory, and during vehicle travel, supplies electric current from the first electrical storage device to the vehicle accessory by causing step-down operation to be executed in the voltage transducer. It is thereby possible to drive the vehicle accessory by reducing loss in proportion to not going through the voltage transducer during external charging, and possible to drive the vehicle accessory by causing step-down operation to be done in the voltage transducer during vehicle travel.

In the fifth aspect of the present invention, the second external charger is connected to the second circuit, and the first external charger having a higher charging voltage than this second external charger is connected to the first circuit. Since it is thereby possible to supply electric current directly from the first external charger to the first electrical storage device without going through the voltage transducer during external charging by the first external charger, it is possible to reduce loss in proportion thereto. In other words, where there is also a case of the first and second external chargers of different charging voltages being jointly used, by connecting the first, second external charger to the aforementioned such positions according to the highs and lows of charging voltage, the present invention can realize external charging with little loss, even in the case of either of the external chargers being used.

In the sixth aspect of the present invention, electric current is supplied from the first external charger to the vehicle accessory by causing step-down operation to be executed in the voltage transducer, during external charging by way of the first external charger. It is thereby possible to supply electric current to the vehicle accessory to drive this, even if a case of either of the first and second external chargers being used.

The seventh aspect of the present invention provides a first electrical storage device to the first circuit, and provides a second electrical storage device having a lower voltage during full charge than this first electrical storage device to the second circuit. Then, during external charging by way of the first external charger, electric current is supplied to the second electrical storage device from the first external charger by way of causing step-down operation to be executed in the voltage transducer, while directly supplying electric current from the first external charger to the first electrical storage device without going through the voltage transducer. In the case of the first external charger being used, it is thereby possible to realize low-loss external charging to at least the first electrical storage device without going through the voltage transducer. On the other hand, during external charging by way of the second external charger, electric current is directly supplied from the second external charger to the second electrical storage device without going through the voltage transducer, while supplying electric current from the second external charger via the voltage transducer or bypass line to the first electrical storage device depending on the first voltage thereof. In the case of the second external charger being used, it is thereby possible to realize external charging which reduces the loss as much as possible also to the first electrical storage device depending on the voltage thereof, while realizing low-loss external charging to the second electrical storage device without going through the voltage transducer.

In the eighth aspect of the present invention, the first circuit to which the first electrical storage device is provided and the second circuit to which the second electrical storage device is provided are connected by the voltage transducer having a step-up function. In addition, the bypass line is provided which connects this first circuit and second circuit to circumvent the voltage transducer, and a diode is provided to this bypass line and passes electric current from the second circuit side to the first circuit side. Then, the control device, during charging of the first electrical storage device by the second external charger, causes the voltage transducer to stop, and supplies electric current from the second electrical storage device to the first electrical storage device via the bypass line using the potential difference between the second electrical storage device and the first electrical storage device, in a case of the value of the first charging parameter having a correlation with the charging amount of the first electrical storage device being less than the determination value associated with the charging voltage of the second electrical storage device. Therefore, according to the present invention, since it is possible to supply electric current from the second electrical storage device to the first electrical storage device by circumventing the voltage transducer during low voltage of the first electrical storage device, it is possible to reduce the loss during charging with the second electrical storage device as the electric power supply source in proportion thereto.

### BRIEF DESCRIPTION OF THE DRAWINGS

FIG. 1 is a view showing the configurations of an electric vehicle equipped with an electric power supply unit according to a first embodiment of the present invention and two external chargers;

FIG. 2 is a flowchart showing a specific sequence of external charging by a low-voltage external charger;

FIG. 3 is a circuit diagram for explaining the flow of electric current during step-up operation;

FIG. 4 is a flowchart showing a specific sequence of external charging by a high-voltage external charger;

FIG. 5 is a circuit diagram for explaining the flow of electric current during step-down operation;

FIG. 6 is a view showing the configurations of an electric vehicle equipped with an electric power supply according to a second embodiment of the present invention and two external chargers; and

FIG. 7 is a flowchart showing a specific sequence of charging of a high-voltage battery during vehicle travel.

### DETAILED DESCRIPTION OF THE INVENTION

### First Embodiment

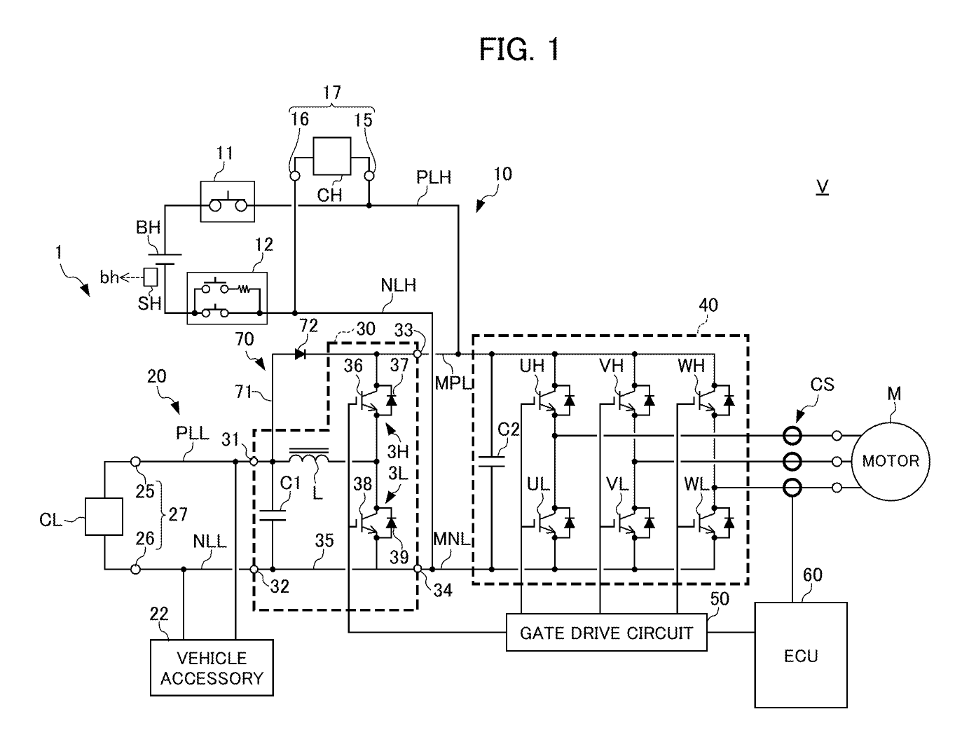

Hereinafter, a first embodiment of the present invention will be explained while referencing the drawings. FIG. 1 is a view showing configurations of an electric vehicle V (hereinafter referred to simply as “vehicle”) equipped with an electric power supply unit 1 according to the present embodiment; and the two types of external chargers CH, CL for this vehicle V.

The high-voltage external charger CH serving as a first external charger and a low-voltage external charger CL serving as a second external charger are each quick chargers installed to charging stations, commercial buildings, public facilities, etc., which are facilities with the main object of charging. These external chargers CH, CL each output DC current of predetermined charging voltages to the power supply 1 of the vehicle V via a charging cable. The charging voltage of the high-voltage external charger CH is higher than the charging voltage of the low-voltage external charger CL. Hereinafter, a case of setting the charging voltage of the high-voltage external charger CH as 1000 [V] and setting the charging voltage of the low-voltage external charger CL as 500 [V] will be explained, for example; however, the present invention is not to be limited thereto.

Both terminals of the positive and negative electrode of the high-voltage external charger CH, when connecting a charging connector provided to the leading end of the charging cable thereof to a inlet (not illustrated) of the vehicle V, are connected to a high-voltage external positive terminal 15 and high-voltage external negative terminal 16 described later, which are provided to the power supply unit 1. In addition, both terminals of the positive/negative electrode of the low-voltage external charger CL, when connecting the charging connector provided to the leading end of this charging cable to the inlet of the vehicle V, are connected to a low-voltage external positive terminal 25 and low-voltage external negative terminal 26 described later, which are provided to the power supply 1.

In addition, the external charger CH (CL), when connecting to both terminals 15, 16 (25, 26) of the power supply unit 1, become able to supply electric power from the external charger CH (CL) to the power supply unit 1, whereby it becomes possible to perform PLC communication, which is communication via electrical lines between the external charger CH (CL) and an ECU 60 described later of the power supply unit 1.

It should be noted that, although FIG. 1 illustrates a state in which the two external chargers CH, CL are both connected to the vehicle V for convenience of explanation, these two external chargers CH, CL cannot be simultaneously connected to one vehicle V, and it is possible to selectively connect only either one. In other words, it is configured so that, in the case of connecting the high-voltage external charger CH to the vehicle V, it is not possible to connect the low-voltage external charger CL to the same vehicle V, and in the case of connecting the low-voltage external charger CL to the vehicle V, it is not possible to connect the low-voltage external charger CL to the same vehicle V.

The vehicle V includes a drive motor M which is mechanically coupled with a drive wheels thereof (not illustrated), and the power supply unit 1 which supplies electric power to this drive motor M. The drive motor M is a three-phase AC motor, for example.

The power supply unit 1 includes: a high-voltage circuit 10 to which a high-voltage battery BH serving as a first electrical storage device is provided; a low-voltage circuit 20 to which a vehicle accessory 22 is connected; a voltage transducer 30 (hereinafter abbreviation as “VCU (Voltage Control Unit) 30” is used); a bypass circuit 70, an inverter 40; a main positive line MPL and main negative line MNL connecting the VCU 30 and inverter 40; a gate drive circuit 50 which drives a plurality of switching elements provided to the VCU 30 and inverter 40; a current sensor CS; and the ECU 60, which is an electronic control module controlling these.

The high-voltage circuit 10 includes: a positive line PLH connecting the positive electrode of the high-voltage battery BH and the main positive line MPL; a negative line NLH connecting the negative electrode of the high-voltage battery BH and the main negative line MNL; a positive contactor 11 provided to the positive line PLH; a negative contactor 12 provided to the negative line NLH; a high-voltage external positive terminal 15 provided in the positive line PLH more to the side of the main positive line MPL than the positive contactor 11; and the high-voltage external negative terminal 16 provided in the negative line NLH more to the side of the main negative line MNL than the negative contactor 12.

The high-voltage battery BH is a rechargeable battery for which both discharging that converts chemical energy into electrical energy, and charging that converts electrical energy into chemical energy are possible.

Hereinafter, a case of using a so-called lithium ion storage-battery that performs charging/discharging by lithium ions migrating between electrodes as this high-voltage battery BH will be explained; however, the present invention is not to be limited thereto.

It should be noted that a case of using a battery for which the voltage during full charge thereof is higher than the output voltage of the low-voltage external charger CL and lower than the output voltage of the high-voltage external charger CH as the high-voltage battery BH will be explained hereinafter. More specifically, the voltage during full charge of the high-voltage battery BH is defined as 800 [V], for example; however, the present invention is not to be limited thereto.

In addition, a sensor unit SH is provided to this high-voltage battery BH. The sensor unit SH is configured by a plurality of sensors which detect a physical quantity required in order to acquire a charging rate of the high-voltage battery BH (a value expressing a proportion of remaining capacity of the battery relative to full charge capacity in percentage; hereinafter referred to as “SOC (State Of Charge)”), and send detection signals bh according to the detection value to the ECU 60. More specifically, the sensor unit SH is configured by a voltage sensor that detects the voltage of the high-voltage battery BH, a current sensor that detects the electric current of the high-voltage battery BH, a temperature sensor that detects the temperature of the high-voltage battery BH, etc. The SOC of the high-voltage battery BH during execution of external charging and during travel is successively calculated in the ECU 60, for example, based on an existing algorithm using the detection signals bh from the sensor unit SH.

The contactors 11, 12 are normal-open type which sever the conduction of the high-voltage battery BH with the terminals 15, 16 and lines MPL, MNL by opening in a state in which a command signal from outside is not being inputted, and connect the high-voltage battery BH with the terminals 15, 16 and lines MPL, MNL by closing in a state in which a command signal is being inputted. These contactors 11, 12 open/close in response to the command signal sent from the ECU 60. It should be noted that the negative contactor 12 becomes a precharge contactor having a precharge resistance for mitigating rush current to the capacitor.

To the high-voltage external positive terminal 15 and high-voltage external negative terminal 16, the positive output terminal and negative output terminal of the high-voltage external charger CH are respectively connected. Hereinafter, these two terminals 15, 16 will collectively be referred to as high-voltage terminal 17.

The low-voltage circuit 20 includes: a low-voltage external positive terminal 25 and a low-voltage external negative terminal 26; a positive line PLL that connects the low-voltage external positive terminal 25 and a low-voltage side positive terminal 31 of the VCU 30; a negative line NLL that connects the low-voltage external negative terminal 26 and a low-voltage side negative terminal 32 of the VCU 30; and the vehicle accessory 22 connected to this positive line PLL and negative line NLL.

The vehicle accessory 22 is configured by a plurality of accessories such as a battery heater, air conditioner inverter and DC-DC converter; and an accessory battery (for example, lead battery) serving as the power source for driving these accessories.

To the low-voltage external positive terminal 25 and low-voltage external negative terminal 26, the positive output terminal and negative output terminal of the low-voltage external charger CL are respectively connected. Hereinafter, these two terminals 25, 26 are collectively referred to as low-voltage external terminals 27.

The VCU 30 is provided between the high-voltage circuit 10 and low-voltage circuit 20. The low-voltage side positive terminal 31 and low-voltage side negative terminal 32 of the VCU 30 are respectively connected to the positive line PLL and negative line NLL of the low-voltage circuit 20 as mentioned above. The high-voltage side positive terminal 33 and high-voltage side negative terminal 34 of the VCU 30 are respectively connected to the positive line PLH and negative line NLH of the high-voltage circuit 10 via the main positive line MPL and main negative line MHL.

The VCU 30 is a bidirectional DC-DC converter configured by combining a reactor L, a smoothing capacitor C1, a high-arm element 3H, a low-arm element 3L, and a negative bus 35.

The negative bus 35 is wiring that connects the low-voltage side negative terminal 32 and the high-voltage side negative terminal 34. The smoothing capacitor C1 has one end side connected to the low-voltage side positive terminal 31 and the other end side connected to the negative bus 35. The reactor L has one end side thereof connected to the low-voltage side positive terminal 31, and the other end side thereof connected to a connection node between the high-arm element 3H and low-arm element 3L.

The high-arm element 3H includes a high-arm switching element 36, and a diode 37 that is connected in parallel to this high-arm switching element 36. The low-arm element 3L includes a low-arm switching element 38, and a diode 39 that is connected in parallel to this low-arm switching element 38. These switching elements 36, 38 are connected in series between the high-voltage side positive terminal 33 and the negative bus 35. A collector of the high-arm switching element 36 is connected to the high-voltage side positive terminal 33. An emitter of the low-arm switching element 38 is connected to the negative bus 35. The forward direction of diode 37 is a direction from the reactor L towards the high-voltage side positive terminal 33. The forward direction of the diode 39 is a direction from the negative bus 35 towards the reactor L. It should be noted that an existing power switching element such as IGBT or MOSFET is used as these switching elements 36, 38, respectively.

The high-arm switching element 36 and low-arm switching element 38 are turned ON or OFF according to a gate drive signal generated by the gate drive circuit 50 based on the control signal from the ECU 60, respectively.

According to the VCU 30 configured in the above way, by driving ON/OFF the switching elements 36, 38 by the gate drive signal generated at a predetermined timing from the gate drive circuit 50, a step-up function and step-down function are exhibited as explained in detail later. Step-up function refers to a function of boosting the voltage applied between low-voltage side terminals 31, 32 and outputting to between the high-voltage side terminals 33, 34, whereby the electric current is flowed from the low-voltage circuit 20 to the high-voltage circuit 10 and inverter 40. In addition, step-down function refers to a function of dropping the voltage applied to between the high-voltage side terminals 33, 34 and outputting to between the low-voltage side terminals 31, 32, whereby the electric current is flowed from the high-voltage circuit 10 and inverter 40 to the low-voltage circuit 20.

The bypass circuit 70 includes a bypass line 71 that circumvents the VCU 30 and connects the high-voltage circuit 10 and low-voltage circuit 20; and a bypass diode 72 provided to this bypass line 71 and passing electric current from the low-voltage circuit 20 to the high-voltage circuit 10. By providing such a bypass circuit 70, in the case of the voltage on the side of the low-voltage circuit 20 being higher than the voltage on the side of the high-voltage circuit 10 and inverter 40, even if a state interrupting the driving of the VCU 30 (more specifically, state turning OFF both switching elements 36, 38 of the VCU 30), it is possible to flow the electric current from the low-voltage circuit 20 side to the side of the high-voltage circuit 10 and inverter 40.

The inverter 40, for example, is a PWM inverter by pulse-width modulation, including a bridge circuit configured by bridge connecting a plurality of switching elements (for example, IGBT). The inverter 40 is connected to the main positive line MPL and main negative line MNL at one side, and is connected to the respective coils of the U-phase, V-phase and W-phase of the drive motor M at the other side.

The inverter 40 includes: a high-side U-phase switching element UH and low-side U-phase switching element UL connected to the U-phase of the drive motor M; a high-side V-phase switching element VH and low-side V-phase switching element VL connected to the V-phase of the drive motor M; a high-side W-phase switching element WH and low-side W-phase switching element WL connected to the W-phase of the drive motor M; a bridge circuit configured by bridge connecting every phase; and a smoothing capacitor C2. The current sensor CS detects the electric current of each phase of the drive motor M, and sends a signal corresponding to the detection value to the ECU 60.

During driving of the vehicle, the ECU 60 generates a torque current command signal using the detection signal of the current sensor CS, and inputs to the gate drive circuit 50. The gate drive circuit 50 generates drive signals to the respective switching elements UH, UL, VH, VL, WH and WL based on the torque current command signals from the ECU 60, and drives these switching elements at predetermined phases. A rotating magnetic field is thereby generated at the stator coil of the drive motor M, and the output shaft of the drive motor M rotates.

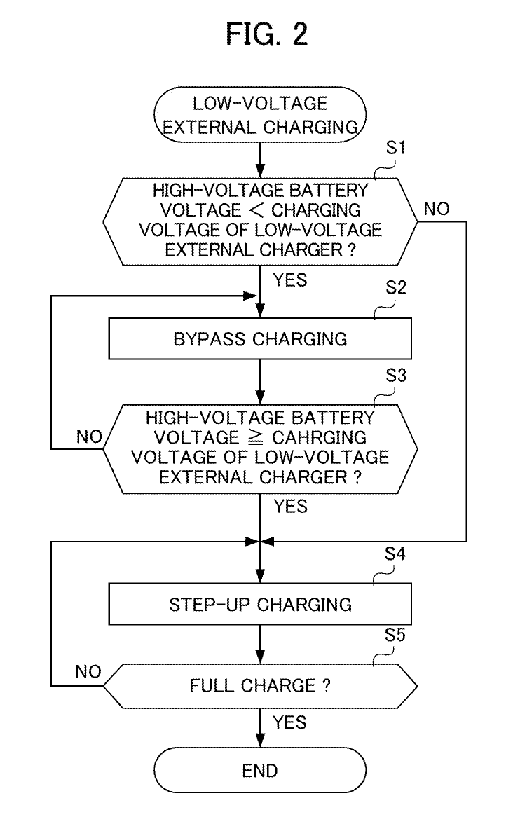

Next, the specific sequence of external charging by the low-voltage external charger CL will be explained. FIG. 2 is a flowchart showing the specific sequence of external charging by the low-voltage external charger CL. The processing shown in FIG. 2 is executed in the ECU 60 in response to entering a state in which supply of electric power from the low-voltage external charger CL to the power supply unit 1 and PLC communication between the low-voltage external charger CL and ECU 60 are possible, by the low-voltage external charger CL being connected to the low-voltage external terminal 27, for example, and the contactors 11 and 12 further being turned ON.

First, in S1, the ECU 60 acquires the voltage of the high-voltage battery BH using the detection signal bh from the sensor unit SH, and judges whether or not the voltage of this high-voltage battery BH is lower than the charging voltage of the low-voltage external charger CL (500 [V] in the present embodiment). In the case of the judgment result in S1 being YES, the ECU 60 advances to S2, and in the case of being NO, advances to S4.

In S2, the ECU 60 interrupts driving of the VCU 30, executes bypass charging using the bypass circuit 70, and advances to S3. In the case of the voltage of the high-voltage battery BH being lower than the charging voltage of the low-voltage external charger CL as mentioned above, when interrupting the driving of the VCU 30, the electric current is supplied from the low-voltage external charger CL to the high-voltage battery BH via the bypass line 71, whereby the high-voltage battery BH is charged. It should be noted that, during execution of this bypass charging, the electric current is supplied from the low-voltage external charger CL to the high-voltage battery BH via the bypass line 71, and the electric current is supplied from the low-voltage external charger CL to the vehicle accessory 22 via the low-voltage circuit 20 at the same time.

In S3, the ECU 60 judges whether or not the voltage of the high-voltage battery BH is at least the charging voltage of the low-voltage external charger CL. In the case of the judgment result of S3 being YES, the ECU 60 advances to S4, and in the case of being NO, returns to S2 and continues bypass charging.

In S4, the ECU 60 executes the step-up charging to charge the high-voltage battery BH by causing step-up operation to be executed in the VCU 30, and supplying electric current from the low-voltage external charger CL to the high-voltage battery BH using the step-up function of the VCU 30, and then advances to S5.

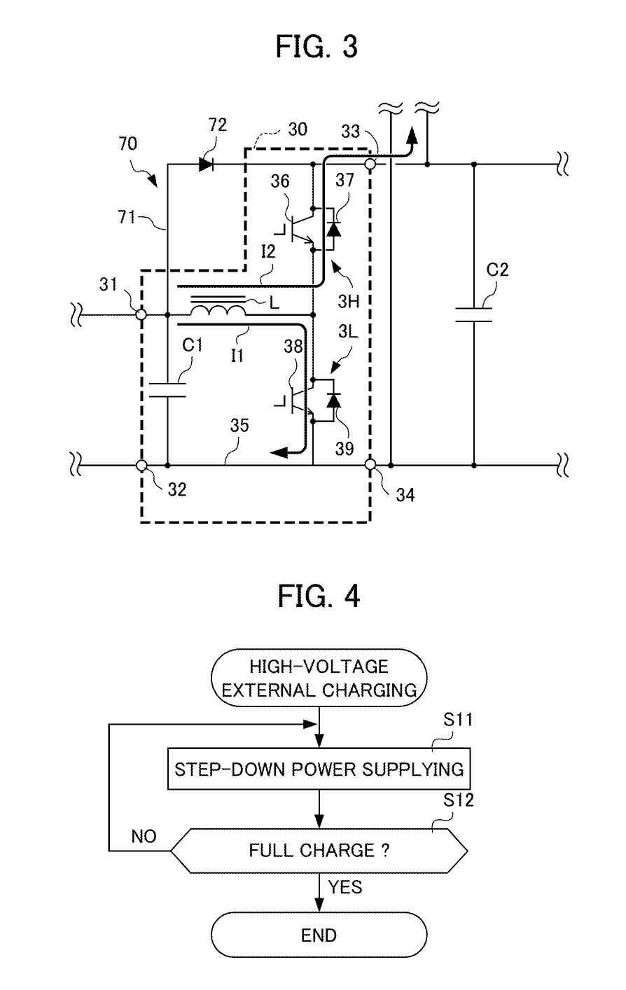

FIG. 3 is a circuit diagram for explaining the flow of electric current during step-up operation. First, when turning ON the low-arm switching element 38 of the VCU 30, the energy is stored in the reactor L by the electric current I1 supplied from the low-voltage external charter CL, and the electric current is flowed from the smoothing capacitor C2 to the high-voltage battery BH. Subsequently, when turning OFF the low-arm switching element 38, the energy stored in the reactor L is flowed to the high-voltage battery BH via the diode 37 as discharge current I2, and the energy is stored in the smoothing capacitor C2. During step-up operation, electric current is supplied from the low-voltage external charger CL to the high-voltage battery BH by turning ON/OFF the low-arm switching element 38 at a predetermined cycle according to the above such sequence. It should be noted that, during this step-up operation, the high-arm switching element 36 continues to turn ON/OFF at a predetermined cycle or stays OFF.

Referring back to FIG. 2, in S4, the ECU 60 charges the high-voltage battery BH with the electric current from the low-voltage external charger CL, by way of executing step-up operation in the VCU 30 according to the above such sequence. It should be noted that, during execution of this step-up charging, electric current from the low-voltage external charger CL is supplied to the high-voltage battery BH via the VCU 30, and electric current from the low-voltage external charger CL is supplied to the vehicle accessory 22 via the low-voltage circuit 20 at the same time.

In S5, the ECU 60 judges whether or not the high-voltage battery BH has reached full charge. The ECU 60 ends the processing of FIG. 2 in the case of the judgment result in S5 being YES, and returns to S4 and continues performing step-up charging in the case of being NO. It should be noted that, the subject determining whether or not the high-voltage battery BH has reached full charge in S5 may be the ECU 60, or may be the low-voltage external charger CL.

Next, the specific sequence of external charging by the high-voltage external charger CH will be explained. FIG. 4 is a flowchart showing the specific sequence of external charging by the high-voltage external charger CH. The processing shown in FIG. 4 is executed in the ECU 60 in response to entering a state in which supply of electric power from the high-voltage external charger CH to the power supply unit 1 and PLC communication between the high-voltage external charger CH and the ECU 60 are possible by the high-voltage external charger CH being connected to the high-voltage external terminals 17, for example, and the contactors 11 and 12 further being turned ON.

First, in S11, the ECU 60 executes step-down power supplying that charges the high-voltage battery BH, while supplying the electric current to the vehicle accessory 22 by causing step-down operation to be executed in the VCU 30, and supplying electric current from the high-voltage external charger CH to the vehicle accessory 22 using the step-down function of the VCU 30.

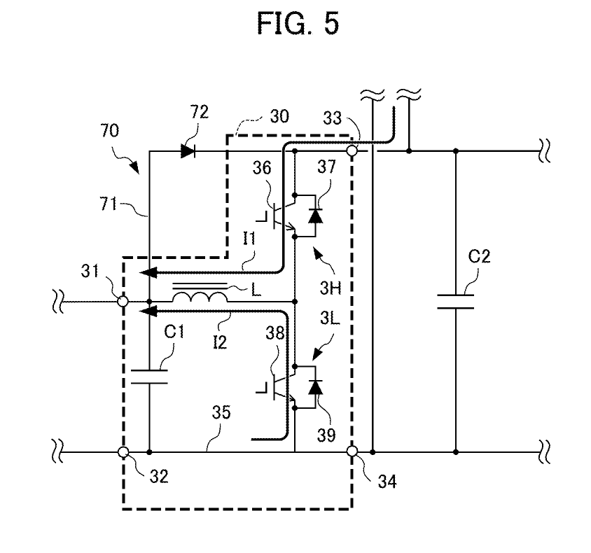

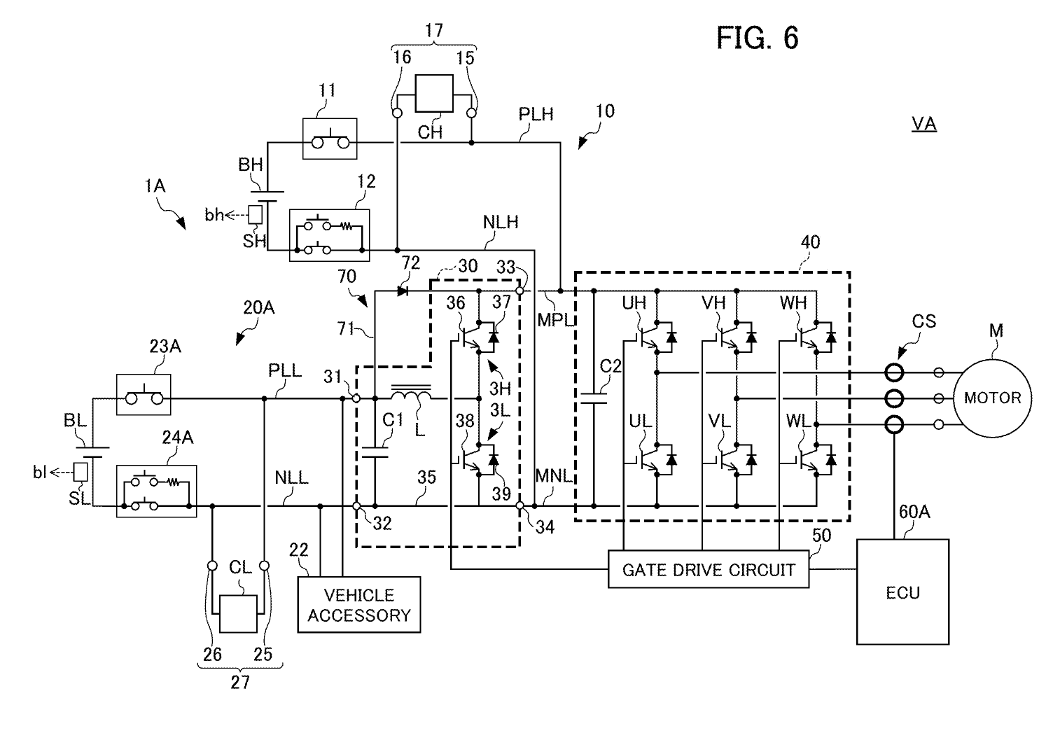

FIG. 5 is a view for explaining the flow of electric current during step-down operation. First, when turning ON the high-arm switching element 36 of the VCU 30, the electric current I1 supplied from the high-voltage external charger CH is flowed through the high-arm switching element 36, energy is stored in the reactor L and smoothing capacitor C1 by this electric current I1, and the vehicle accessory 22 is driven. Subsequently, when turning OFF the high-arm switching element 36, the energy stored in the reactor L is supplied to the vehicle accessory 22 as discharge current I2, and the electric charge stored in the smoothing capacitor C1 is also supplied to the vehicle accessory 22. During step-down operation, electric current is supplied from the high-voltage external charger CH to the vehicle accessory 22, by turning ON/OFF the high-arm switching element 36 at a predetermined cycle according to the above such sequence. It should be noted that, during this step-down operation, the low-arm switching element 38 turns ON/OFF at a predetermined cycle or stays OFF.

Referring back to FIG. 4, in S11, the ECU 60 supplies electric current from the high-voltage external charger CH to the vehicle accessory 22, by causing step-down operation to be executed in the VCU 30 according to the above such sequence. It should be noted that the charging voltage of the high-voltage external charger CH is higher than the voltage during full charge of the high-voltage battery BH, as mentioned above. For this reason, during this step-down power supplying, the electric current from the high-voltage external charger CH is directly supplied to the high-voltage battery 2 without going through the VCU 30.

In S12, the ECU 60 judges whether or not the high-voltage battery BH has reached full charge. The ECU 60 ends the processing of FIG. 4 in the case of the judgment result in S12 being YES, and returns to S11 and continues to perform step-down power supplying in the case of being NO. It should be noted that the determination subject in S12 may be the ECU 60 or may be the high-voltage external charger CH, similarly to the aforementioned S5.

It should be noted that, during vehicle travel, i.e. in a state in which neither of the external chargers CH, CL are connected to the power supply unit 1, the sequence for supplying electric current to the vehicle accessory 22 from the high-voltage battery BH is the same as the step-down power supplying in S11 described above; therefore, an explanation thereof is omitted. In other words, during vehicle travel, the electric current is supplied to the vehicle accessory 22 from the high-voltage battery BH by the ECU 60 causing step-down operation to be executed in the VCU 30.

According to the power supply unit 1 of the present embodiment, the follow effects are exerted.

(1) The power supply unit 1 provides the bypass line 71 which connects the high-voltage circuit 10 and low-voltage circuit 20 to circumvent the VCU 30, and provides in this bypass line 71 the bypass diode 72 which passes electric current from the side of the low-voltage circuit 20 to the side of the high-voltage circuit 10. Then, in the case of the voltage of the high-voltage battery BH being lower than the charging voltage of the low-voltage external charger CL during external charging by the low-voltage external charger CL, the ECU 60 interrupts driving of the VCU 30, and supplies electric current from the low-voltage external charger CL to the high-voltage battery BH via the bypass line 71 using this potential difference. Therefore, according to the power supply unit 1, during low-voltage of the high-voltage battery BH, since it is possible to perform external charging by circumventing the VCU 30, the loss during external charging can be reduced in proportion thereto.
(2) The power supply unit 1, in the case of the voltage of the high-voltage battery BH being at least the charging voltage of the low-voltage external charger CL during external charging by the low-voltage external charger CL, supplies electric current from the low-voltage external charger CL to the high-voltage battery BH by way of causing step-up operation to be executed in the VCU 30. It is thereby possible to make the high-voltage battery BH fully charged by the external charging using the low-voltage external charger CL, even if a case of a battery for which the voltage during full charge is higher than the charging voltage of the low-voltage external charger CL being used as the high-voltage battery BH, for example.
(3) In the case of performing, by way of the low-voltage external charger CL, external charging of the high-voltage battery BH having a voltage during full charge thereof that is higher than the charging voltage of the low-voltage external charger CL, the ECU 60 at first causes the VCU 30 to stop, and executes bypass charging using the bypass line 71. During the external charging initial stage, since it is thereby possible to circumvent the VCU 30 and perform external charging, the loss during external charging can be reduced in proportion thereto. In addition, from after the voltage of the high-voltage battery BH rises to a certain extent by way of external charging via this bypass line 71, until the high-voltage battery BH reaches full charge, it is possible to continue external charging until the voltage of the high-voltage battery BH attains the voltage during full charge, which is higher than the charging voltage, by executing step-up charging using the step-up function of the VCU 30. According to the power supply unit 1, even in a case of the voltage during full charge of the high-voltage battery BH being higher than the charging voltage of the low-voltage external charger CL, it is possible to make the high-voltage battery BH full charge while reducing the loss during external charging.
(4) The power supply unit 1 supplies electric current from the low-voltage external charger CL to the vehicle accessory 22 during external charging by the low-voltage external charger CL, and supplies electric current from the high-voltage battery BH to the vehicle accessory 22 by causing step-down operation to be executed in the VCU 30, during vehicle travel. The vehicle accessory 22 can thereby be driven by reducing the loss in proportion without going through the VCU 30 during external charging, and the vehicle accessory 22 can be driven by having the VCU 30 do step-down operation during vehicle travel.
(5) The power supply unit 1 provides the low-voltage external terminals 27 to which the low-voltage external charger BL is connected to the low-voltage circuit 20, and provides the high-voltage external terminals 17 to which the high-voltage external charger CH having a higher charging voltage than this low-voltage external charger CL is connected to the high-voltage circuit 10. During external charging by way of the high-voltage external charger CH, it is thereby possible to supply electric current directly from the high-voltage external charger CH to the high-voltage battery BH without going through the VCU 30; therefore, loss can be reduced in proportion thereto. In other words, when there is also a case of the external chargers CH, CL of different charging voltages being jointly used, by the power supply unit 1 providing the external terminals 17, 27 at the aforementioned such positions according to the highs and lows of charging voltage, it is possible to realize external charging with little loss, even in the case of either of the external chargers CH, CL being used.
(6) During external charging by the high-voltage external charger CH, the power supply unit 1 supplies electric current from the high-voltage external charger CH to the vehicle accessory 22 by causing step-down operation to be executed in the VCU 30. Even in the case of either of the external chargers CH, CL being used, it is thereby possible to supply electric current to the vehicle accessory 22 to drive this.

### Second Embodiment

Next, a second embodiment of the present invention will be explained while referencing the drawings. FIG. 6 is a view showing the configurations of an electric vehicle VA (hereinafter simply referred to as “vehicle VA”) equipped with a power supply unit 1A according to the present embodiment, and the two types of external chargers CH, CL for this vehicle VA. It should be noted that, in the following explanation, the same reference symbols are attached to configurations that are the same as the vehicle V and power supply unit 1 of the above-mentioned first embodiment, and detailed explanations thereof will be omitted.

The power supply unit 1A differs relative to the power supply unit 1 shown in FIG. 1 in the point of further including a low-voltage battery BL, and the configuration of the low-voltage circuit 20A. The low-voltage circuit 20A includes: a positive line PLL connecting the positive electrode of the low-voltage battery BL and a low-voltage side positive terminal 31 of the VCU 30; a negative line NLL connecting the negative electrode of the low-voltage battery BL and the low-voltage side negative terminal 32 of the VCU 30; a positive contactor 23A provided to the positive line PLL; an negative contactor 24A provided to the negative line NLL; a low-voltage external positive terminal 25 provided in the positive line PLL more to a side of the VCU 30 than the positive contactor 23A; a low-voltage external negative terminal 26 provided in the negative line NLL more to a side of the VCU 30 than the negative contactor 24A; and a vehicle accessory 22 connected to the positive line PLL and negative line NLL more to the side of the VCU 30 than the low-voltage external terminals 27.

The low-voltage battery BL is a rechargeable battery capable of both discharging that converts chemical energy into electrical energy, and charging that converts electrical energy into chemical energy. Hereinafter, a case of using a so-called lithium ion storage-battery that performs charge/discharge by lithium ions migrating between terminals as this high-voltage battery BH will be explained; however, the present invention is not to be limited thereto.

It should be noted that, hereinafter, a case of using a battery for which the voltage during full charge thereof is lower than the output voltage of the low-voltage external charger CL as the low-voltage battery BL will be explained. More specifically, the voltage during full charge of the low-voltage battery BL is set as 260 [V], for example; however, the present invention is not to be limited thereto.

In addition, with the high-voltage battery BH and low-voltage battery BL, there are the following such differences in addition to the voltage during full charge. The high-voltage battery BH has lower output weight density than the low-voltage battery BL; however, the energy weight density is high. In other words, the high-voltage battery BH is more superior than the low-voltage battery BL in the point of energy weight density, and the low-voltage battery BL is more superior than the high-voltage battery BH in the point of output weight density. It should be noted that energy weight density is the electric energy per unit weight [Wh/kg], and output weight density is electric power per unit weight [W/kg]. Therefore, the high-voltage battery BH which excels in energy weight density is an electrical storage device with the main object of high capacity, and the low-voltage battery BL which excels in output weight density is an electrical storage device with the main object of high output.

In addition, a sensor unit SL is provided to this low-voltage battery BL. The sensor unit SL detects a physical quantity required for acquiring the SOC of the low-voltage battery BL, and is configured by a plurality of sensors that send detection signals bl depending on the detection value to the ECU 60A. More specifically, the sensor unit SL is configured by a voltage sensor that detects the voltage of the low-voltage battery BL, a current sensor that detects the electric current of the low-voltage battery BL, a temperature sensor that detects the temperature of the low-voltage battery BL, etc. The SOC of the low-voltage battery BL during execution of external charging and during travel is successively calculated in the ECU 60A, for example, based on an existing algorithm using the detection signals bl from the sensor unit SL.

The contactors 23A, 24A are normal-open type which sever the conduction of the low-voltage battery BL with the low-voltage external terminal 27 and lines MPL, MNL by opening in a state in which a command signal from outside is not being inputted, and connect the low-voltage battery BL with the low-voltage external terminals 27 and lines MPL, MNL by closing in a state in which a command signal is being inputted. These contactors 23A, 24A open/close in response to the command signal sent from the ECU 60A. It should be noted that the negative contactor 24A becomes a precharge contactor having a precharge resistance for mitigating rush current to the capacitor.

The sequence of performing external charging by the low-voltage external charger CL in the power supply unit 1A will be explained. First, the sequence of supplying electric power to the vehicle accessory 22 while performing charging of the high-voltage battery BH using the low-voltage external charger CL is the same as the sequence explained by referencing FIG. 2. In other words, while the voltage of the high-voltage battery BH is lower than the charging voltage of the low-voltage external charger CL, by performing bypass charging (refer to S2 in FIG. 2) by interrupting driving of the VCU 30, and causing step-up operation to be executed in the VCU 30 to perform step-up charging (refer to S4 in FIG. 2) if the voltage of the high-voltage battery BH reaches at least the charging voltage, the electric current from the low-voltage external charger CL is supplied to the high-voltage battery BH and vehicle accessory 22. In addition, the voltage during full charge of the low-voltage battery BL is lower than the charging voltage of the low-voltage external charger CL, as mentioned above. For this reason, in the power supply unit 1A of the present embodiment, electric current from the low-voltage external charger CL is supplied also to the low-voltage battery BL while supplying electric current to the vehicle accessory 22 from the low-voltage external charger CL, by configuring in the aforementioned way. The power supply unit 1A can supply electric current simultaneously to the high-voltage battery BH, low-voltage battery BL and vehicle accessory 22 from the low-voltage external charger CL, according to the above sequence.

Next, the sequence of performing external charging by the high-voltage external charger CH in the power supply unit 1A will be explained. First, the sequence of supplying electric power to the vehicle accessory 22 while performing charging of the high-voltage battery BH using the high-voltage external charger CH is the same as the sequence explained by referencing FIG. 4. In other words, by causing step-down operation to be executed in the VCU 30, electric current is supplied from the high-voltage external charger CH to the vehicle accessory 22 via the VCU 30 while supplying electric current directly from the high-voltage external charger CH to the high-voltage battery BH (refer to S11 in FIG. 4). In addition, when the power supply unit 1A of the present embodiment performs step-down power supplying by configuring in this way, electric current is supplied from the high-voltage external charger CH to the vehicle accessory 22 as well as to the low-voltage battery BL via the VCU 30. The power supply unit 1A can supply electric current simultaneously to the high-voltage battery BH and low-voltage battery BL from the high-voltage external charger CH according to the above sequence.

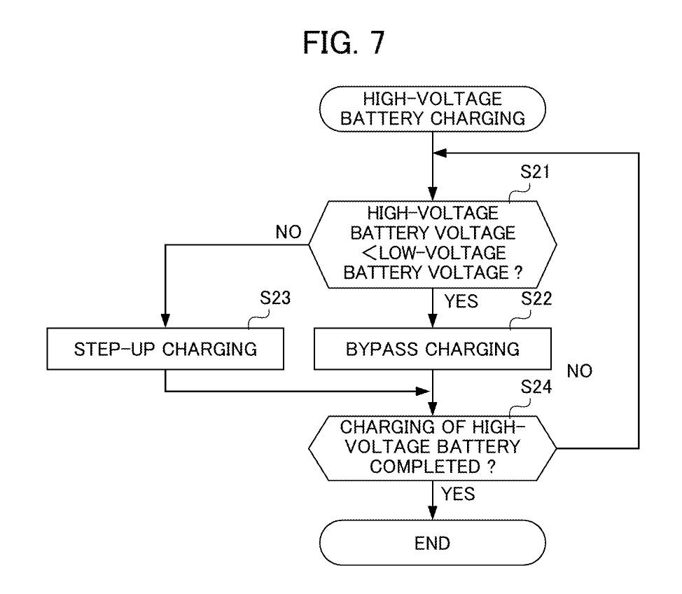

Next, a sequence of performing charging of the high-voltage battery BH by the low-voltage battery BL during vehicle travel in the power supply unit 1A will be explained. FIG. 7 is a flowchart showing a specific sequence of charging of the high-voltage battery BH during vehicle travel. The processing shown in FIG. 7 is executed in the ECU 60A during vehicle travel, i.e. in a state in which neither of the external chargers CH, CL are connected, in response to a charging request of the high-voltage battery BH being produced. Herein, a case of a charging request of the high-voltage battery BH being produced is a case of the SOC of the high-voltage battery BH considerably declining and the SOC of the low-voltage battery BL being close to full charge, for example.

First, in S21, the ECU 60A acquires the voltages of the high-voltage battery BH and low-voltage battery BL using the detection signals bh, bl from the sensor units SH, SL, and judges whether or not the voltage of this high-voltage battery BH is lower than the voltage of the low-voltage battery BL. The ECU 60A advances to S22 in the case of the judgment result in S21 being YES, and advances to S23 in the case of being NO.

In S22, the ECU 60A causes driving of the VCU 30 to stop, executes bypass charging using the bypass circuit 70, and advances to S24. With the power supply unit 1A, in the case of the voltage of the high-voltage battery BH being lower than the voltage of the low-voltage battery BL, when interrupting driving of the VCU 30, electric current is supplied from the low-voltage battery BL to the high-voltage battery BH via the bypass line 71, whereby the high-voltage battery BH is charged. It should be noted that, during executing of this bypass charging, the electric current from the low-voltage battery BL is supplied to the high-voltage battery BH via the bypass line 71.

In S23, the ECU 60A executes step-up charging to charge the high-voltage battery BH by causing step-up operation to be executed in the VCU 30, and supplying electric current from the low-voltage battery BL to the high-voltage battery BH using the step-up function of the VCU 30, and then advances to S24. It should be noted that the specific sequence of step-up charging in S23 is the same as S4 in FIG. 2; therefore, a detailed explanation will be omitted.

In S24, the ECU 60A judges whether or not charging of the high-voltage battery BH has completed. The ECU 60A calculates the respective SOCs of the batteries BH, BL using the detection signals bh, bl from the sensor units SH, SL, and judges whether or not the charging of the high-voltage battery BH has completed using these SOCs. The ECU 60A ends the processing in FIG. 7 in the case of the judgment result in S24 being YES, and returns to S21 in the case of being NO.

According to the power supply unit 1A of the present embodiment, the following effects are exerted.

(7) The power supply unit 1A provides the bypass line 71 which connects the high-voltage circuit 10 and low-voltage circuit 20A to circumvent the VCU 30, and provides the bypass diode 72 to this bypass line 71 to pass electric current from the low-voltage circuit 20A side to the high-voltage circuit 10 side. Then, the ECU 60A, in the case of the voltage of the low-voltage battery BL being higher than the voltage of the high-voltage battery BH during charging of the high-voltage battery BH by the low-voltage battery BL, causes driving of the VCU 30 to stop, and supplies electric current from the low-voltage battery BL to the high-voltage battery BH via the bypass line 71 using this potential difference. Therefore, according to the power supply unit 1A, since it is possible to supply electric current from the low-voltage battery BL to the high-voltage battery BH by circumventing the VCU 30 during low voltage of the high-voltage battery BH, the loss during charging that establishes the low-voltage battery BL as the electric power supply source can be reduced in proportion thereto.
(8) The power supply unit 1A, during external charging by the high-voltage external charger CH, supplies electric current from the high-voltage external charger CH to the low-voltage battery BL by causing the VCU 30 to execute step-down operation, while directly supplying electric current from the high-voltage external charger CH to the high-voltage battery BH without going through the VCU 30. In the case of the high-voltage external charger CH being used, it is thereby possible to realize low-loss external charging to at least the high-voltage battery BH without going through the VCU 30. On the other hand, during external charging by the low-voltage external charger BL, electric current is directly supplied from the low-voltage external charger CL to the low-voltage battery BL without going through the VCU 30, while supplying electric current from the low-voltage external charger CL via the VCU 30 or bypass line 71 to the high-voltage battery BH depending on the voltage thereof. In the case of the low-voltage external charger CL being used, it is thereby possible to realize external charging which reduces loss as much as possible also to the high-voltage battery BH depending on the voltage thereof, while realizing low-loss external charging to the low-voltage battery BL without going through the VCU 30.

Although an embodiment of the present invention has been explained above, the present invention is not limited thereto. The configurations of detailed parts may be modified as appropriate within the scope of the gist of the present invention.

For example, in the processing shown in FIG. 2 of the above-mentioned first embodiment, the voltage of the high-voltage battery BH acquired using the sensor unit SH and the charging voltage of the low-voltage external charger CL are compared in S1 and/or S3; however, the present invention is not limited thereto. The voltage of the high-voltage battery BH has a positive correlation with the SOC of the high-voltage battery BH. In other words, as the voltage of the high-voltage battery BH rises, the SOC thereof also rises. Therefore, in the aforementioned S1 and/or S3, a similar effect is exerted even when comparing the SOC of the high-voltage battery BH acquired using the sensor unit SH with the determination value associated with the charging voltage of the low-voltage external charger CL.

In addition, for example, in the processing shown in FIG. 7 of the above-mentioned second embodiment, the voltage of the high-voltage battery BH and the voltage of the low-voltage battery BL acquired using the sensor units SH, SL are compared in S21; however, the present invention is not limited thereto. The respective voltages of the batteries BH, BL have positive correlations with the respective SOCs, as described above. Therefore, the same effects are exerted even when comparing the SOC of the high-voltage battery BH acquired using the sensor unit SH with the determination value associated with the voltage of the low-voltage battery BL in the above-mentioned S21.
V, VA electric vehicle (vehicle)
1, 1A power supply unit
10 high-voltage circuit (first circuit)
BH high-voltage battery (first electrical storage device)
17 high-voltage external terminal
SH sensor unit (first charging parameter acquisition means)
20, 20A low-voltage circuit (second circuit)
22 vehicle accessory
27 low-voltage external terminal
BL low-voltage battery (second electrical storage device)
SL sensor unit
30 VCU (voltage transducer)
31 low-voltage side positive terminal
32 low-voltage side negative terminal
33 high-voltage side positive terminal
34 high-voltage side negative terminal
70 bypass circuit
71 bypass line (bypass line)
72 bypass diode (diode)
60, 60A ECU (control device)
CH high-voltage external charger (first external charger)
CL low-voltage external charger (second external charger)

What is claimed is:

1. A power supply unit for a vehicle, comprising:
a first circuit to which a first electrical storage device is provided;
a second circuit to which a second external charger is connected;
a voltage transducer having a step-up function of connecting the first circuit and the second circuit, boosting a voltage applied to a side of the second circuit, and outputting to a side of the first circuit;
a control device that controls the voltage transducer;
a first charging parameter acquisition means for acquiring a value of a first charging parameter having a correlation with a charging amount of the first electrical storage device;
a bypass line that connects the first circuit and the second circuit to circumvent the voltage transducer; and
a diode that is provided to the bypass line and causes electric current to pass from the side of the second circuit to the side of the first circuit,
wherein the control device, during external charging by the second external charger, stops the voltage transducer, and supplies electric current from the second external charger to the first electrical storage device via the bypass line, in a case of the value of the first charging parameter being smaller than the determination value associated with the charging voltage of the second external charger.

2. The power supply unit for a vehicle according to claim 1, wherein the control device, during external charging by the second external charger, supplies electric current from the second external charger to the first electrical storage device by causing step-up operation to be executed in the voltage transducer, in a case of the value of the first charging parameter being at least the determination value.

3. The power supply unit for a vehicle according to claim 2, wherein the voltage transducer further has a step-down function of dropping a voltage applied to the side of the first circuit and outputting to the side of the second circuit,
wherein a vehicle accessory is connected to the second circuit, and
wherein electric current from the second external charger is supplied during external charging by the second external charger, and electric current from the first electrical storage device is supplied by causing step-down operation to be executed in the voltage transducer during vehicle travel, to the vehicle accessory.

4. The power supply unit for a vehicle according to claim 1, wherein the voltage transducer further has a step-down function of dropping a voltage applied to the side of the first circuit and outputting to the side of the second circuit,
wherein a vehicle accessory is connected to the second circuit, and
wherein electric current from the second external charger is supplied during external charging by the second external charger, and electric current from the first electrical storage device is supplied by causing step-down operation to be executed in the voltage transducer during vehicle travel, to the vehicle accessory.

5. The power supply unit for a vehicle according to claim 3, wherein a first external charger having a higher charging voltage than the second external charger is connected to the first circuit, and
wherein electric current from the first external charger is supplied to the first electrical storage device during external charging by way of the first external charger.

6. The power supply unit for a vehicle according to claim 1, wherein a first external charger having a higher charging voltage than the second external charger is connected to the first circuit, and
wherein electric current from the first external charger is supplied to the first electrical storage device during external charging by way of the first external charger.

7. The power supply unit for a vehicle according to claim 2, wherein a first external charger having a higher charging voltage than the second external charger is connected to the first circuit, and
wherein electric current from the first external charger is supplied to the first electrical storage device during external charging by way of the first external charger.

8. The power supply unit for a vehicle according to claim 4, wherein a first external charger having a higher charging voltage than the second external charger is connected to the first circuit, and
wherein electric current from the first external charger is supplied to the first electrical storage device during external charging by way of the first external charger.

9. The power supply unit for a vehicle according to claim 3,
wherein a first external charger having a higher charging voltage than the second external charge is connected to the first circuit, and
wherein the control device, during external charging by the first external charger, supplies electric current from the first external charger to the vehicle accessory by way of causing the voltage transducer to execute step-down operation.

10. The power supply unit for a vehicle according to claim 4,
wherein a first external charger having a higher charging voltage than the second external charge is connected to the first circuit, and
wherein the control device, during external charging by the first external charger, supplies electric current from the first external charger to the vehicle accessory by way of causing the voltage transducer to execute step-down operation.

11. The power supply unit according to claim 6, wherein a second electrical storage device having a lower voltage during full charge than the first electrical storage device is provided to the second circuit, and
wherein electric current from the first external charger is supplied by causing the voltage transducer to execute step-down operation during external charging by way of the first external charger, and electric current from the second external charger is supplied during external charging by way of the second external charger, to the second electrical storage device.

12. The power supply unit according to claim 7, wherein a second electrical storage device having a lower voltage during full charge than the first electrical storage device is provided to the second circuit, and
wherein electric current from the first external charger is supplied by causing the voltage transducer to execute step-down operation during external charging by way of the first external charger, and electric current from the second external charger is supplied during external charging by way of the second external charger, to the second electrical storage device.

13. The power supply unit according to claim 8, wherein a second electrical storage device having a lower voltage during full charge than the first electrical storage device is provided to the second circuit, and
wherein electric current from the first external charger is supplied by causing the voltage transducer to execute step-down operation during external charging by way of the first external charger, and electric current from the second external charger is supplied during external charging by way of the second external charger, to the second electrical storage device.

14. A power supply unit for a vehicle, comprising:
a first circuit to which a first electrical storage device is provided;
a second circuit to which a second external charger is connected;
a voltage transducer having a step-up function of connecting the first circuit and the second circuit, boosting a voltage applied to a side of the second circuit, and outputting to a side of the first circuit;
a control device that controls the voltage transducer;
a bypass line that connects the first circuit and the second circuit to circumvent the voltage transducer; and
a diode that is provided to the bypass line and causes electric current to pass from the side of the second circuit to the side of the first circuit,
wherein a voltage during full charge of the first electrical storage device is higher than a charging voltage of the second external charger, and
wherein the control device, during external charging by the second external charger, first causes the voltage transducer to stop and supplies electrical current from the second external charger to the first electrical storage device via the bypass line, and subsequently, until the first electrical storage device reaches full charge, causes step-up operation to be executed in the voltage transducer and supplies electrical current from the second external charger to the first electrical storage device.

15. The power supply unit for a vehicle according claim 14, wherein the voltage transducer further has a step-down function of dropping a voltage applied to the side of the first circuit and outputting to the side of the second circuit,
wherein a vehicle accessory is connected to the second circuit, and
wherein electric current from the second external charger is supplied during external charging by the second external charger, and electric current from the first electrical storage device is supplied by causing step-down operation to be executed in the voltage transducer during vehicle travel, to the vehicle accessory.

16. The power supply unit for a vehicle according to claim 15, wherein a first external charger having a higher charging voltage than the second external charger is connected to the first circuit, and
wherein electric current from the first external charger is supplied to the first electrical storage device during external charging by way of the first external charger.

17. The power supply unit for a vehicle according to claim 14, wherein a first external charger having a higher charging voltage than the second external charger is connected to the first circuit, and
wherein electric current from the first external charger is supplied to the first electrical storage device during external charging by way of the first external charger.

18. The power supply unit for a vehicle according to claim 15,
wherein a first external charger having a higher charging voltage than the second external charge is connected to the first circuit, and
wherein the control device, during external charging by the first external charger, supplies electric current from the first external charger to the vehicle accessory by way of causing the voltage transducer to execute step-down operation.

19. The power supply unit according to claim 17, wherein a second electrical storage device having a lower voltage during full charge than the first electrical storage device is provided to the second circuit, and
wherein electric current from the first external charger is supplied by causing the voltage transducer to execute step-down operation during external charging by way of the first external charger, and electric current from the second external charger is supplied during external charging by way of the second external charger, to the second electrical storage device.

20. A power supply unit for a vehicle, comprising:
a first circuit to which a first electrical storage device is provided;
a second circuit to which a second electrical storage device is provided;
a voltage transducer having a step-up function of connecting the first circuit and the second circuit, and boosting a voltage applied to a side of the second circuit and outputting to a side of the first circuit;
a first charging parameter acquisition means for acquiring a value of a first charging parameter having a correlation with a charging amount of the first electrical storage device;
a control device that controls the voltage transducer;
a bypass line that connects the first circuit and the second circuit to circumvent the voltage transducer; and
a diode that is provided to the bypass line and causes electric current to pass from the side of the second circuit to the side of the first circuit,
wherein the control device, during charging of the first electrical storage device by way of the second electrical storage device, causes the voltage transducer to stop, and supplies electric current from the second electrical storage device to the first electrical storage device via the bypass line, in a case of a value of the first charging parameter being less than a determination value associated with the voltage of the second electrical storage device.
